(19) United States
(12) Patent Application Publication
(10) Pub. No.: US 2013/0083963 A1
(43) Pub. Date: Apr. 4, 2013

(54) ELECTRONIC CAMERA

(71) Applicant: SANYO ELECTRIC CO., LTD., Moriguchi City (JP)

(72) Inventor: Masayoshi Okamoto, Daito City (JP)

(73) Assignee: SANYO ELECTRIC CO., LTD., Moriguchi City (JP)

(21) Appl. No.: 13/630,208

(22) Filed: Sep. 28, 2012

(30) Foreign Application Priority Data
Sep. 29, 2011 (JP) 2011-213783

(51) Int. Cl. G06K 9/00

(52) U.S. Cl. 382/103

(57) ABSTRACT

An electronic camera includes an imager. An imager repeatedly outputs an image representing a scene captured on an imaging surface. A searcher searches for a specific object image from the image outputted from the imager by executing a plurality of comparing processes respectively corresponding to a plurality of postures possibly taken by the imager in a direction around an axis orthogonal to the imaging surface. An executer executes a processing operation different depending on a search result of the searcher. A recorder repeatedly records the image outputted from the imager in parallel with a process of the imager. A restrictor executes a restricting process of restricting the comparing process executed by the searcher to any one of the plurality of comparing processes, in association with a process of the recorder.

### CROSS REFERENCE OF RELATED APPLICATION

The disclosure of Japanese Patent Application No. 2011-213783, which was filed on Sep. 29, 2011, is incorporated herein by reference.

### BACKGROUND OF THE INVENTION

1. Field of the Invention

The present invention relates to an electronic camera, and in particular, relates to an electronic camera which searches for an image coincident with a specific object image from a designated image.

2. Description of the Related Art

According to one example of this type of camera, resulting from controlling a camera control section by a control section, shooting a photograph or a video is executed in response to a shutter being depressed. Resulting from controlling an acceleration-sensor control section by the control section, detecting a tilt angle of a cell-phone at a time of the shutter being depressed is executed by an acceleration sensor. Thus, a control for storing the shot photograph or video into a storing section is performed. Moreover, resulting from controlling a face detecting process section, an operation for detecting a face portion of a person from the shot image is executed. At this time, tilt angle data of the cell-phone at the time of the shutter being depressed detected by the acceleration sensor is acquired, and resulting from controlling an image rotation section by the acquired tilt angle data, a rotating process for a photographed image is executed according to an tile angle.

However, in the above-described camera, the rotation process for the photographed image is executed according to the tilt angle detected by the acceleration sensor, and therefore, it is necessary to mount the acceleration sensor on the camera in order to execute the rotation process. On the other hand, when the acceleration sensor is not mounted on the camera because of a weight saving of the camera or a cost reduction, it is impossible to directly acquire a tilt of the photographed image. Thus, a load of a process of detecting the face portion of the person from the photographed image is increased, and therefore, a searching performance may be deteriorated.

### SUMMARY OF THE INVENTION

An electronic camera according to the present invention comprises: an imager which repeatedly outputs an image representing a scene captured on an imaging surface; a searcher which searches for a specific object image from the image outputted from the imager by executing a plurality of comparing processes respectively corresponding to a plurality of postures possibly taken by the imager in a direction around an axis orthogonal to the imaging surface; an executer which executes a processing operation different depending on a search result of the searcher; a recorder which repeatedly records the image outputted from the imager in parallel with a process of the imager; and a restrictor which executes a restricting process of restricting the comparing process executed by the searcher to any one of the plurality of comparing processes, in association with a process of the recorder.

According to the present invention, an imaging control program recorded on a non-transitory recording medium in order to control an electronic camera provided with an imager which repeatedly outputs an image representing a scene captured on an imaging surface, the program causing a processor of electronic camera to perform the steps comprises: a searching step of searching for a specific object image from the image outputted from the imager by executing a plurality of comparing processes respectively corresponding to a plurality of postures possibly taken by the imager in a direction around an axis orthogonal to the imaging surface; an executing step of executing a processing operation different depending on a search result of the searching step; a recording step of repeatedly recording the image outputted from the imager in parallel with a process of the imager; and a restricting step of executing a restricting process of restricting the comparing process executed by the searching step to any one of the plurality of comparing processes, in association with a process of the recording step.

According to the present invention, an imaging control method executed by an electronic camera provided with an imager which repeatedly outputs an image representing a scene captured on an imaging surface, comprises: a searching step of searching for a specific object image from the image outputted from the imager by executing a plurality of comparing processes respectively corresponding to a plurality of postures possibly taken by the imager in a direction around an axis orthogonal to the imaging surface; an executing step of executing a processing operation different depending on a search result of the searching step; a recording step of repeatedly recording the image outputted from the imager in parallel with a process of the imager; and a restricting step of executing a restricting process of restricting the comparing process executed by the searching step to any one of the plurality of comparing processes, in association with a process of the recording step.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of a mapping state of an SDRAM applied to the embodiment in FIG. 2;

FIG. 4 is an illustrative view showing one example of an assignment state of an evaluation area in an imaging surface;

FIG. 5 is an illustrative view showing one example of a face-detection frame structure used in a face detecting process;

FIG. 6(A) is an illustrative view showing one example of a configuration of a face dictionary referred to in the face detecting process;

FIG. 6(B) is an illustrative view showing one example of a configuration of another face dictionary referred to in the face detecting process;

FIG. 6(C) is an illustrative view showing one example of a configuration of still another face dictionary referred to in the face detecting process;

FIG. 7(A) is an illustrative view showing one example of a posture of a camera housing;

FIG. 7(B) is an illustrative view showing one example of another posture of the camera housing;

FIG. 7(C) is an illustrative view showing one example of still another posture of the camera housing;

FIG. 8 is an illustrative view showing one portion of the face detecting process;

FIG. 9 is an illustrative view showing one example of a configuration of a register referred to in the embodiment in FIG. 2;

FIG. 10 is an illustrative view showing one example of a configuration of another register referred to in the embodiment in FIG. 2;

FIG. 11 is an illustrative view showing one example of an image displayed on an LCD monitor in an imaging task;

FIG. 12 is a flowchart showing one portion of behavior of a CPU applied to the embodiment in FIG. 2;

FIG. 13 is a flowchart showing another portion of behavior of the CPU applied to the embodiment in FIG. 2;

FIG. 14 is a flowchart showing still another portion of behavior of the CPU applied to the embodiment in FIG. 2;

FIG. 15 is a flowchart showing yet another portion of behavior of the CPU applied to the embodiment in FIG. 2;

FIG. 16 is a flowchart showing another portion of behavior of the CPU applied to the embodiment in FIG. 2;

FIG. 17 is a flowchart showing still another portion of behavior of the CPU applied to the embodiment in FIG. 2;

FIG. 18 is a flowchart showing yet another portion of behavior of the CPU applied to the embodiment in FIG. 2;

FIG. 19 is a flowchart showing another portion of behavior of the CPU applied to the embodiment in FIG. 2;

FIG. 20 is a flowchart showing still another portion of behavior of the CPU applied to the embodiment in FIG. 2;

FIG. 21 is a flowchart showing yet another portion of behavior of the CPU applied to the embodiment in FIG. 2;

FIG. 22 is a flowchart showing another portion of behavior of the CPU applied to the embodiment in FIG. 2;

FIG. 23 is a flowchart showing one portion of behavior of the CPU applied to another embodiment of the present invention;

FIG. 24 is a flowchart showing another portion of behavior of the CPU applied to another embodiment of the present invention; and

FIG. 25 is a block diagram showing a configuration of another embodiment of the present invention.

### DETAILED DESCRIPTION OF THE PREFERRED EMBODIMENTS

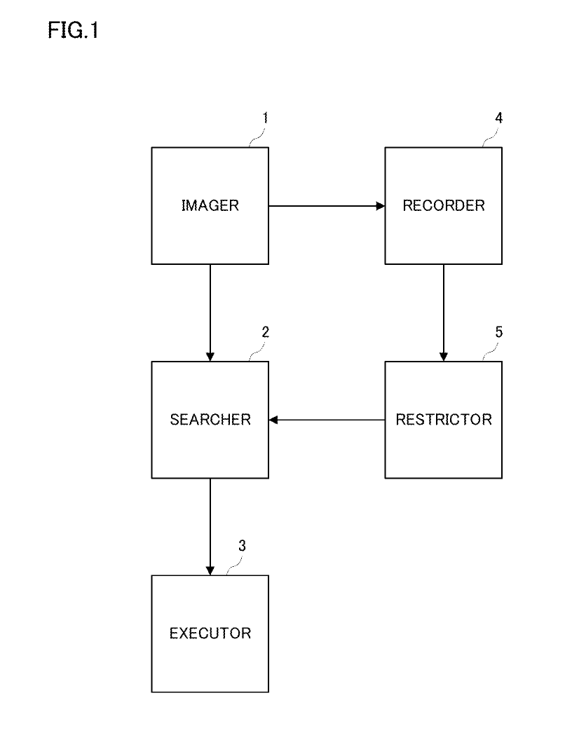

With reference to FIG. 1, an electronic camera according to one embodiment of the present invention is basically configured as follows: An imager 1 repeatedly outputs an image representing a scene captured on an imaging surface. A searcher 2 searches for a specific object image from the image outputted from the imager 1 by executing a plurality of comparing processes respectively corresponding to a plurality of postures possibly taken by the imager 1 in a direction around an axis orthogonal to the imaging surface. An executer 3 executes a processing operation different depending on a search result of the searcher 2. A recorder 4 repeatedly records the image outputted from the imager 1 in parallel with a process of the imager 1. A restrictor 5 executes a restricting process of restricting the comparing process executed by the searcher 2 to any one of the plurality of comparing processes, in association with a process of the recorder 4.

A specific object image is searched from the image outputted from the imager 1 by executing the plurality of comparing processes respectively corresponding to the plurality of postures of the camera. The comparing process executed by the searching process is restricted in association with a recording process. In the recording process, the image repeatedly outputted from the imager 1 is repeatedly recorded in parallel with an outputting process. That is, a moving image is recorded.

Usually, upon recording the moving image, a posture of the camera is stabilized, and therefore, it has no effect on searching the specific object even when a part of the plurality of comparing processes respectively corresponding to the plurality of postures of the camera is restricted to execute. Therefore, it becomes possible to reduce a load of the searching process by restricting the comparing process. Thus, a searching performance is improved.

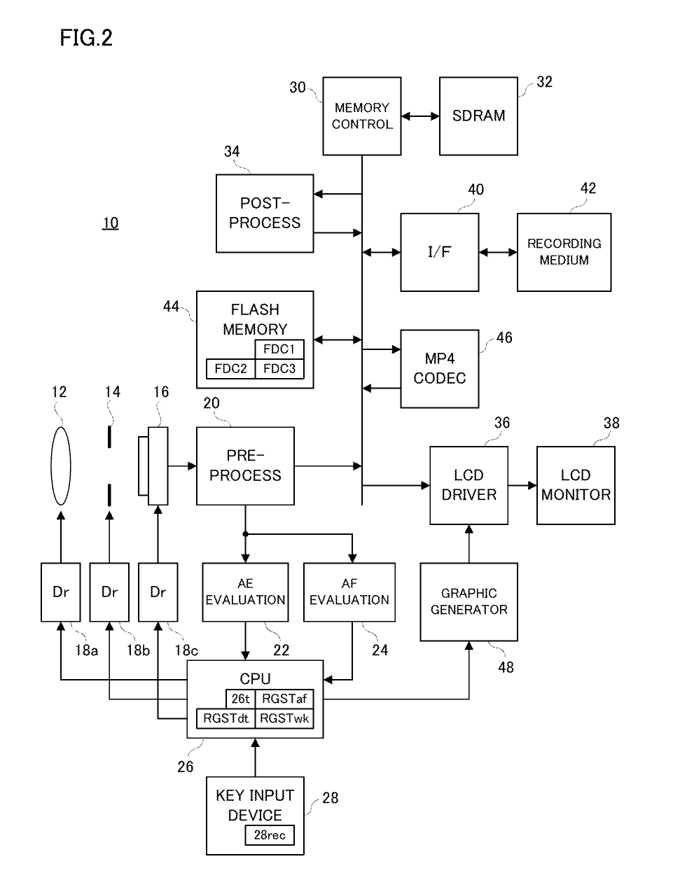

With reference to FIG. 2, a digital video camera 10 according to one embodiment includes a focus lens 12 and an aperture unit 14 driven by drivers 18a and 18b, respectively. An optical image of a scene that underwent these components enters, with irradiation, an imaging surface of an image sensor 16, and is subjected to a photoelectric conversion.

When a power source is applied, in order to execute a moving-image taking process, a CPU 26 commands a driver 18c to repeat an exposure procedure and an electric-charge reading-out procedure under an imaging task. In response to a vertical synchronization signal Vsync periodically generated from an SG (Signal Generator) not shown, the driver 18c exposes the imaging surface of the image sensor 16 and reads out the electric charges produced on the imaging surface of the image sensor 16 in a raster scanning manner. From the image sensor 16, raw image data that is based on the read-out electric charges is cyclically outputted.

A pre-processing circuit 20 performs processes, such as digital clamp, pixel defect correction, gain control and etc., on the raw image data outputted from the image sensor 16. The raw image data on which these processes are performed is written into a raw image area 32a of an SDRAM 32 through a memory control circuit 30 (see FIG. 3).

A post-processing circuit 34 reads out the raw image data stored in the raw image area 32a through the memory control circuit 30, and performs a color separation process, a white balance adjusting process and a YUV converting process, on the read-out raw image data. The YUV formatted image data produced thereby is written into a YUV image area 32b of the SDRAM 32 through the memory control circuit 30 (see FIG. 3).

Furthermore, the postprocessing circuit 34 executes a zoom process for display and a zoom process for search to the image data that comply with a YUV format, in a parallel manner. As a result, display image data and search image data that comply with the YUV format is individually created. The display image data is written into a display image area 32c of the SDRAM 32 by the memory control circuit 30 (see FIG. 3). The search image data is written into a search image area 32d of the SDRAM 32 by the memory control circuit 30 (see FIG. 3).

An LCD driver 36 repeatedly reads out the display image data stored in the display image area 32c through the memory control circuit 30, and drives an LCD monitor 38 based on the read-out image data. As a result, a real-time moving image (a live view image) representing the scene is displayed on the LCD monitor 38.

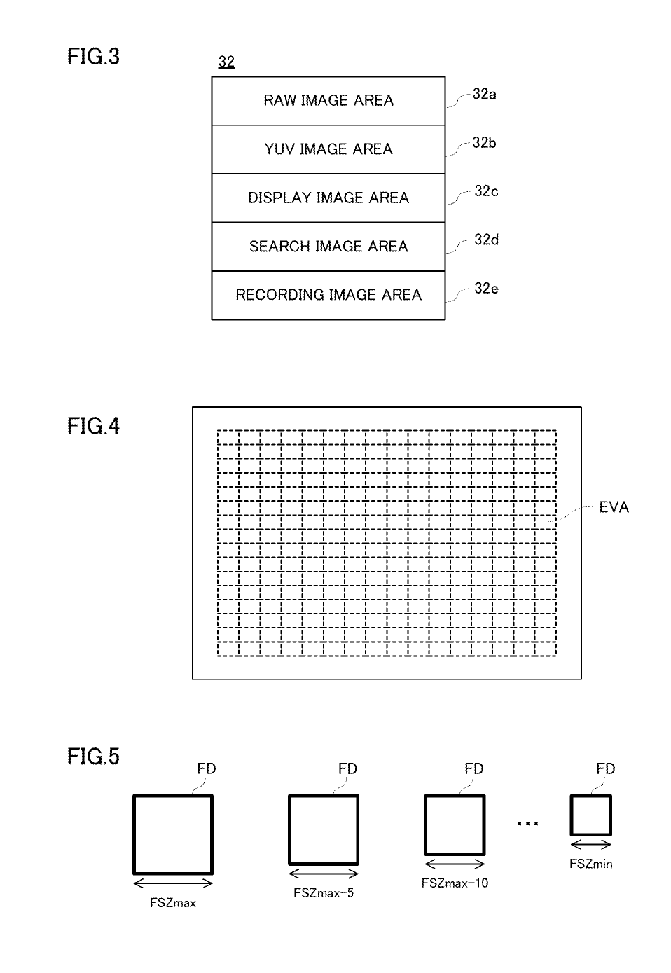

With reference to FIG. 4, an evaluation area EVA is assigned to a center of the imaging surface of the image sensor 16. The evaluation area EVA is divided into 16 portions in each of a horizontal direction and a vertical direction; therefore, 256 divided areas form the evaluation area EVA. Moreover, in addition to the above-described processes, the pre-processing circuit 20 shown in FIG. 2 executes a simple RGB converting process which simply converts the raw image data into RGB data.

An AE evaluating circuit 22 integrates RGB data belonging to the evaluation area EVA, out of the RGB data produced by the pre-processing circuit 20, at every time the vertical synchronization signal Vsync is generated. Thereby, 256 integral values (256 AE evaluation values) are outputted from the AE evaluating circuit 22 in response to the vertical synchronization signal Vsync. An AF evaluating circuit 24 integrates a high-frequency component of the RGB data belonging to the evaluation area EVA, out of the RGB data generated by the pre-processing circuit 20, at every time the vertical synchronization signal Vsync is generated. Thereby, 256 integral values (256AF evaluation values) are outputted from the AF evaluating circuit 24 in response to the vertical synchronization signal Vsync. Processes based on thus acquired AE evaluation values and the AF evaluation values will be described later.

When a plurality of dictionaries face detecting task executed in parallel with the imaging task is activated, the CPU 26 sets a flag FLG_f to “0” as an initial setting. Moreover, under the plurality of dictionaries face detecting task, in order to declare that a single dictionary face detecting task described later is being stopped, the CPU 26 sets a flag FLG_s to “0” as an initial setting.

Subsequently, under the plurality of dictionaries face detecting task, the CPU 26 executes a face detecting process in order to search for a face image of a person from the search image data stored in the search image area 32d, at every time the vertical synchronization signal Vsync is generated.

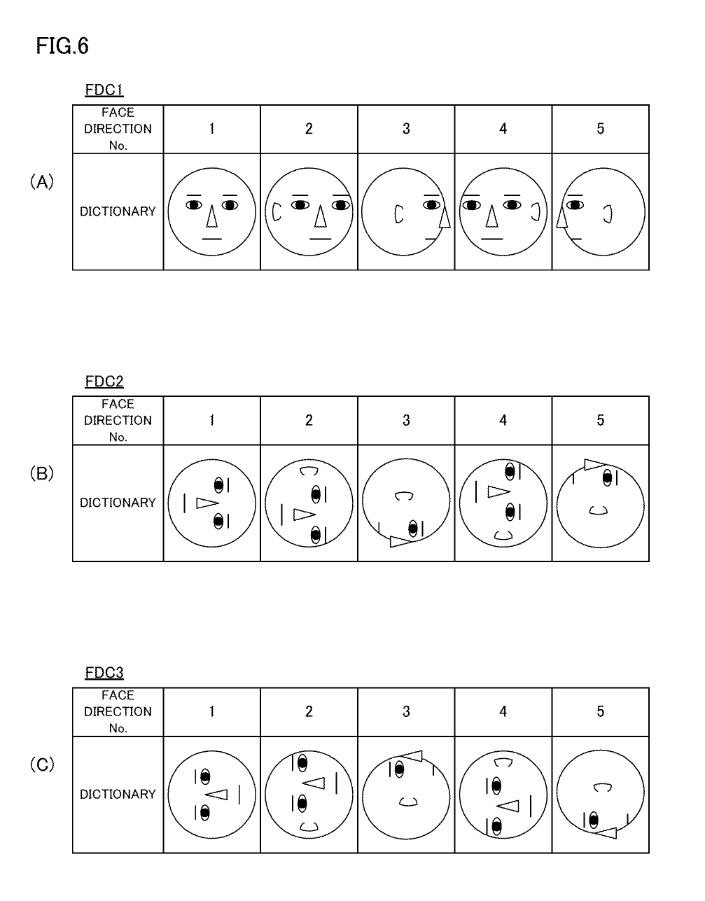

In the face detecting process, used are a face-detection frame structure FD of which the size is adjusted as shown in FIG. 5 and face dictionaries FDC1 to FDC3 each containing five dictionary images (=face images of which directions are mutually different) shown in FIG. 6 (A) to FIG. 6 (C).

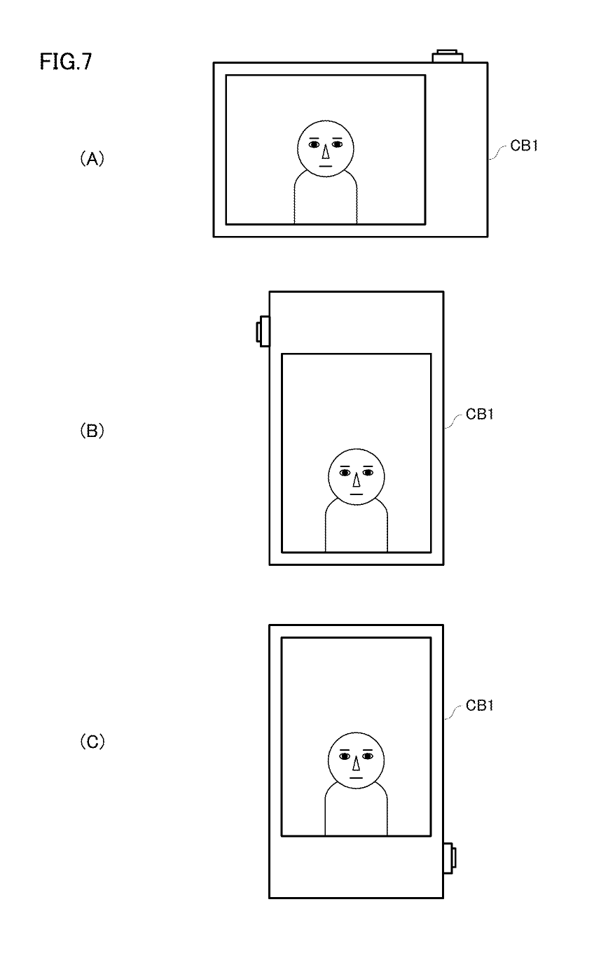

The five dictionary images contained in the face dictionary FDC1 are prepared in order to detect the face image of the person from search image data when a housing CB1 of the digital camera 10 is horizontally held as shown in FIG. 7 (A).

The five dictionary images contained in each of the face dictionaries FDC2 and FDC3 are prepared in order to detect the face image of the person from search image data when the housing CB1 of the digital camera 10 is vertically held.

Specifically, the face dictionary FDC2 is used for detecting a face when the housing CB1 of the digital camera 10 is held so that a right side surface is in upside as shown in FIG. 7 (B). That is, the face dictionary FDC2 is used for detecting the face when a posture of the housing CB1 shown in FIG. 7 (A) is held in a state of being rotated 90 degrees anticlockwise as viewed from a rear surface, around an optical axis of the digital camera 10 orthogonal to the imaging surface of the image sensor 16.

Moreover, the face dictionary FDC3 is used for detecting a face when the housing CB1 of the digital camera 10 is held so that a left side surface is in upside as shown in FIG. 7 (C). That is, the face dictionary FDC3 is used for detecting the face when the posture of the housing CB1 shown in FIG. 7 (A) is held in a state of being rotated 90 degrees clockwise as viewed from a rear surface, around the optical axis of the digital camera 10 orthogonal to the imaging surface of the image sensor 16.

It is noted that the face dictionary FDC1 corresponds to a dictionary number 1, the face dictionary FDC2 corresponds to a dictionary number 2, the face dictionary FDC3 corresponds to a dictionary number 3. Moreover, the face dictionaries FDC1 to FDC3 are stored in a flash memory 44.

In the face detecting process, firstly, the whole evaluation area EVA is set as a search area. Moreover, in order to define a variable range of the size of the face-detection frame structure FD, a maximum size SZmax is set to “200”, and a minimum size SZmin is set to “20”.

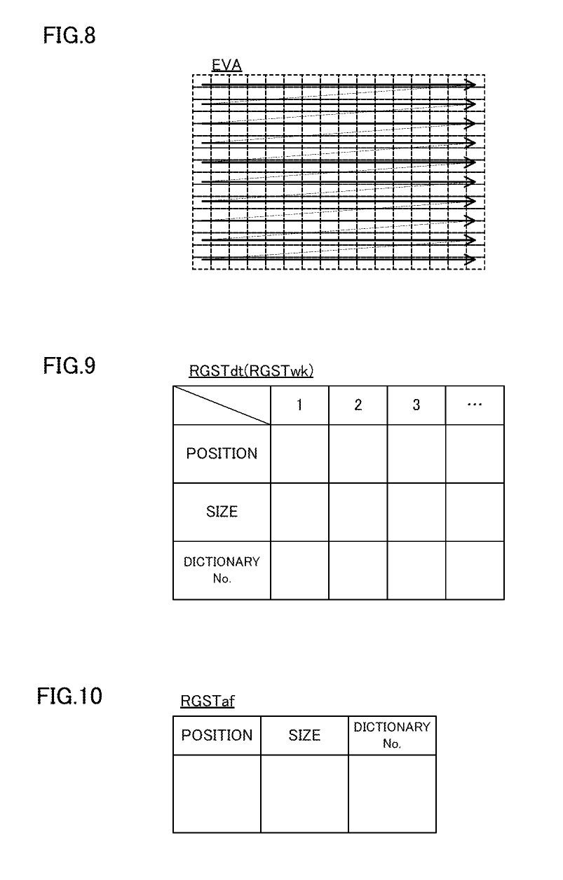

The face-detection frame structure FD is moved by each predetermined amount in the raster scanning manner, from a start position (an upper left position) toward an ending position (a lower right position) of the search area (see FIG. 8). Moreover, the size of the face-detection frame structure FD is reduced by a scale of “5” from “SZmax” to “SZmin” at every time the face-detection frame structure FD reaches the ending position.

Partial search image data belonging to the face-detection frame structure FD is read out from the search image area 32d through the memory control circuit 30. A characteristic amount of the read-out search image data is compared with a characteristic amount of each of the five dictionary images contained in each of the face dictionaries FDC1 to FDC3. When a matching degree exceeding a threshold value TH is obtained, it is regarded that the face image has been detected. A position and a size of the face-detection frame structure FD at a current time point and a dictionary number of a face dictionary of a comparing target are registered, as face information, in a work register RGSTwk shown in FIG. 9.

When there is a registration of the face information in the work register RGSTwk after the face detecting process is completed, a registration content of the work register RGSTwk is copied on a face-detection register RGSTdt shown in FIG. 9.

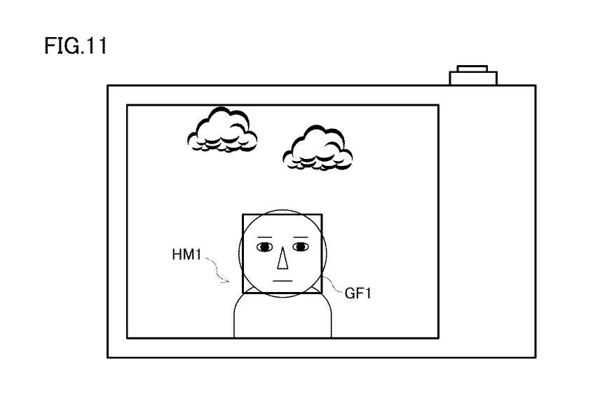

The CPU 26 determines an AF target region from among regions each of which is indicated by the position and size registered in the face-detection register RGSTdt. When one face information is registered in the face-detection register RGSTdt, the CPU 26 uses the region indicated by the registered position and size as the AF target region. When a plurality of face information is registered in the face-detection register RGSTdt, the CPU 26 uses a region indicated by face information having the largest size as the AF target region. When a plurality of face information indicating the maximum size is registered, the CPU 26 uses a region nearest to a center of a scene out of the regions indicated by these face information as the AF target region. A position and a size of the face information used as the AF target region and a dictionary number of a face dictionary of a comparing target are registered in an AF target register RGSTaf shown in FIG. 10.

Moreover, in order to declare that a person has been discovered, the CPU 26 sets the flag FLG_f to “1”.

It is noted that, when there is no registration of the face information in the work register RGSTwk upon completion of the face detecting process, that is, when the face of the person is not discovered, the CPU 26 sets the flag FLG_f to “0” in order to declare that the face of the person is undiscovered.

When the flag FLG_f indicates “0”, under an AE/AF control task executed in parallel with the imaging task, the CPU 26 executes a continuous AF process in which a center of the scene is noticed. The CPU 26 extracts, out of the 256 AF evaluation values outputted from the AF evaluating circuit 24, AF evaluation values corresponding to a predetermined region of the center of the scene, and executes a continuous AF process that is based on the extracted partial AF evaluation values. As a result, the focus lens 12 is placed at a focal point in which the center of the scene is noticed, and thereby, a sharpness of a live view image or a recorded image is continuously improved.

When the flag FLG_f indicates “0”, under the AE/AF control task, the CPU 26 also executes an AE process in which the whole scene is considered, based on the 256 AE evaluation values outputted from the AE evaluating circuit 22. An aperture amount and an exposure time period defining an optimal EV value calculated by the AE process are respectively set to the drivers 18b and 18c. As a result, a brightness of the live view image or the recorded image is adjusted by considering the whole scene.

When the flag FLG_f is updated to “1”, under the imaging task, the CPU 26 requests a graphic generator 48 to display a face frame structure GF with reference to a registration content of the face-detection register RGSTdt. The graphic generator 48 outputs graphic information representing the face frame structure GF toward the LCD driver 36. The face frame structure GF is displayed on the LCD monitor 38 in a manner to be adapted to the position and size of the face image detected under the face detecting task.

Thus, when a face of a person HM1 is captured on the imaging surface, a face frame structure GF1 is displayed on the LCD monitor 38 as shown in FIG. 11, in a manner to surround a face image of the person HM1.

Moreover, when the flag FLG_f is updated to “1”, under the AE/AF control task, the CPU 26 executes a continuous AF process in which the AF target region is noticed. The CPU 26 extracts, out of the 256 AF evaluation values outputted from the AF evaluating circuit 24, AF evaluation values corresponding to the position and size registered in the AF target register RGSTaf. The CPU 26 executes an AF process that is based on the extracted partial AF evaluation values. As a result, the focus lens 12 is placed at a focal point in which the AF target region is noticed, and thereby, a sharpness of an AF target region in a live view image or a recorded image is improved.

Subsequently, under the AE/AF control task, the CPU 26 extracts, out of the 256 AE evaluation values outputted from the AE evaluating circuit 22, AE evaluation values corresponding to the position and size registered in the face-detection register RGSTdt. The CPU 26 executes an AE process in which the face image is noticed, based on the extracted partial AE evaluation values. An aperture amount and an exposure time period defining an optimal EV value calculated by the AE process are respectively set to the drivers 18b and 18c. As a result, a brightness of the live view image or the recorded image is adjusted by noticing the face image.

When a recording start operation is performed toward a recording button 28rec arranged in a key input device 28, the CPU 26 activates an MP4 codec 46 and an I/F 40 under the imaging task in order to start the recording process. The MP4 codec 46 reads out the image data stored in the YUV image area 32b through the memory control circuit 30, and compresses the read-out image data according to the MPEG4 format. The compressed image data, i.e., MP4 data is written into a recording image area 32e by the memory control circuit 30 (see FIG. 3). The I/F 40 reads out the MP4 data stored in the recording image area 32e through the memory control circuit 30, and writes the read-out MP4 data into an image file created in a recording medium 42.

Moreover, when the flag FLG_f indicates “1” after the recording start operation is performed, the CPU 26 stops the plurality of dictionaries face detecting task that is being executed and activates the single dictionary face detecting task. Under the single dictionary face detecting task, in order to declare that the single dictionary face detecting task is being executed, the CPU 26 sets the flag FLG_s to “1” as an initial setting.

Subsequently, under the single dictionary face detecting task, the CPU 26 executes the face detecting process in order to search for the face image of the person from the search image data stored in the search image area 32d, at every time the vertical synchronization signal Vsync is generated.

In the face detecting process executed under the single dictionary face detecting task, used is only a dictionary corresponding to the dictionary number registered in the AF target register RGSTaf out of the face dictionaries FDC1 to FDC3. In the face detecting process executed under the single dictionary face detecting task, executed is a process same as the face detecting process executed under the plurality of dictionaries face detecting task except that a dictionary of a comparing target is single. Thus, when a matching degree exceeding the threshold value TH is obtained as a result of comparing the characteristic amount of the search image data with the characteristic amount of the dictionary image, a position and a size of the face-detection frame structure FD and a dictionary number of the face dictionary of the comparing target are registered in the work register RGSTwk.

When there is a registration of the face information in the work register RGSTwk after the face detecting process is completed, similarly to the plurality of dictionaries face detecting task, a registration content of the work register RGSTwk is copied on a face-detection register RGSTdt.

Similarly to the plurality of dictionaries face detecting task, the CPU 26 determines the AF target region from among the regions each of which is indicated by the face information registered in the face-detection register RGSTdt, and the position and size of the face information used as the AF target and the dictionary number of the face dictionary of the comparing target are registered in the AF target register RGSTaf. Moreover, the CPU 26 sets the flag FLG_f to “1” when the face of the person has been discovered while sets the flag FLG_f to “0” when the face of the person has not been discovered.

Moreover, when the flag FLG_f is updated and indicates “0” after the recording start operation is performed toward the key input device 28, the CPU 26 stops the single dictionary face detecting task that is being executed in a case where a predetermined time period (three seconds, for example) has elapsed since a timing of activating the single dictionary face detecting task.

Subsequently, the CPU 26 activates the plurality of dictionaries face detecting task so as to execute the face detecting process once. Since the face detecting process is executed under the plurality of dictionaries face detecting task, the face dictionaries FDC1 to FDC3 are used as the dictionaries of the comparing target. The CPU 26 stops the plurality of dictionaries face detecting task and restarts the single dictionary face detecting task before a second face detecting process is executed.

It is noted that, when the dictionary number of the face dictionary of the comparing target registered in the AF target register RGSTaf is updated to a new dictionary number by the face detecting process executed once under the plurality of dictionaries face detecting task, a face dictionary corresponding to the updated dictionary number is used in the face detecting process executed under the restarted the single dictionary face detecting task. When a recording end operation is performed toward the key input device 28, the CPU 26 stops the MP4 codec 46 and the I/F 40 in order to end the recording process. Moreover, a moving-image file that is a writing destination is subjected to an ending operation.

Moreover, in a case where the flag FLG_s indicates “1” when the recording end operation is performed, the CPU 26 stops the single dictionary face detecting task that is being executed and restarts the plurality of dictionaries face detecting task. Under the restarted plurality of dictionaries face detecting task, the CPU 26 sets the flag FLG_s to “0” in order to declare that the single dictionary face detecting task is being stopped.

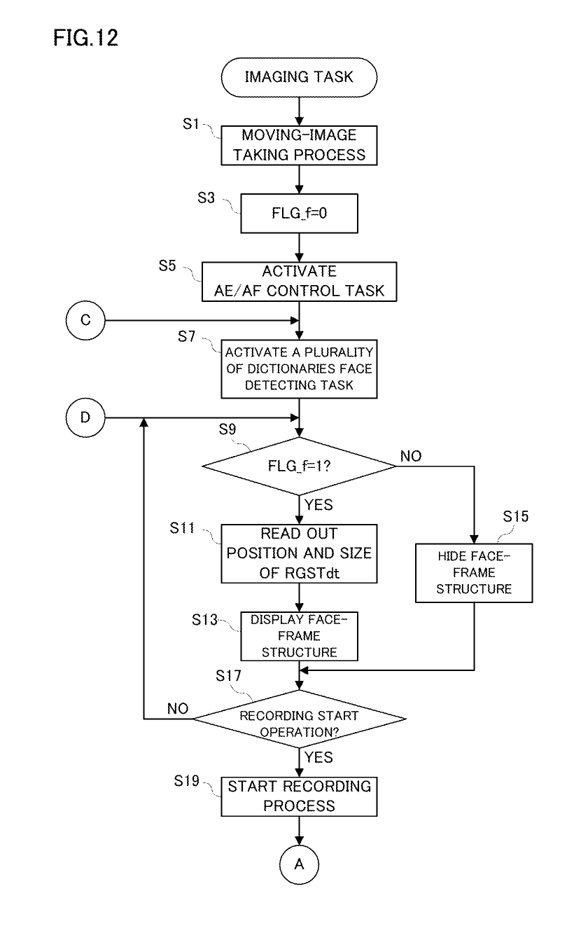

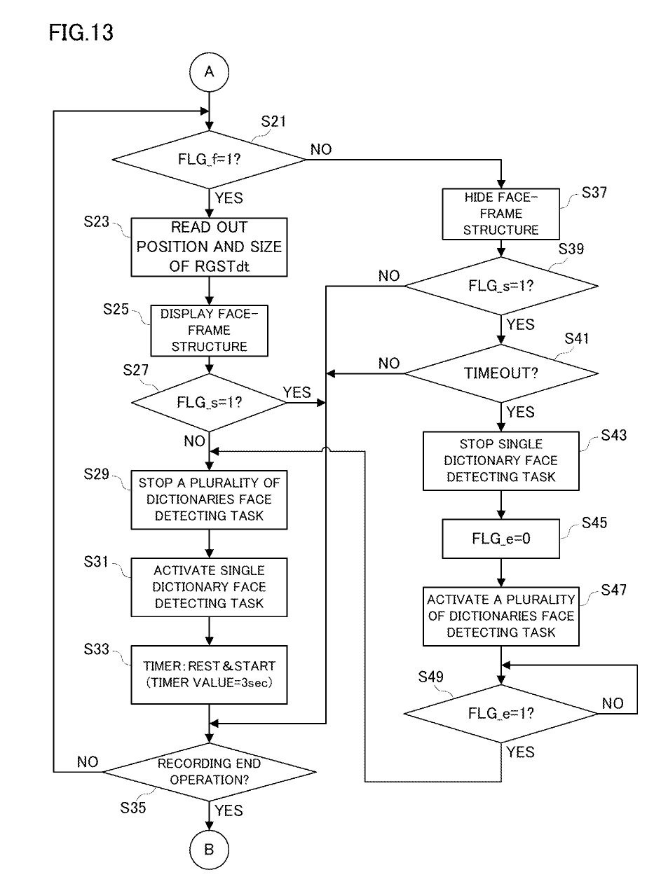

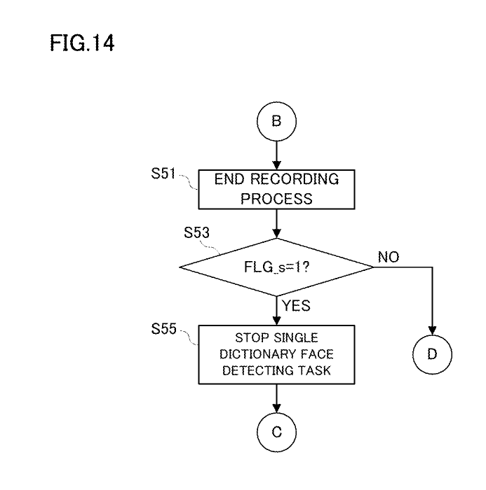

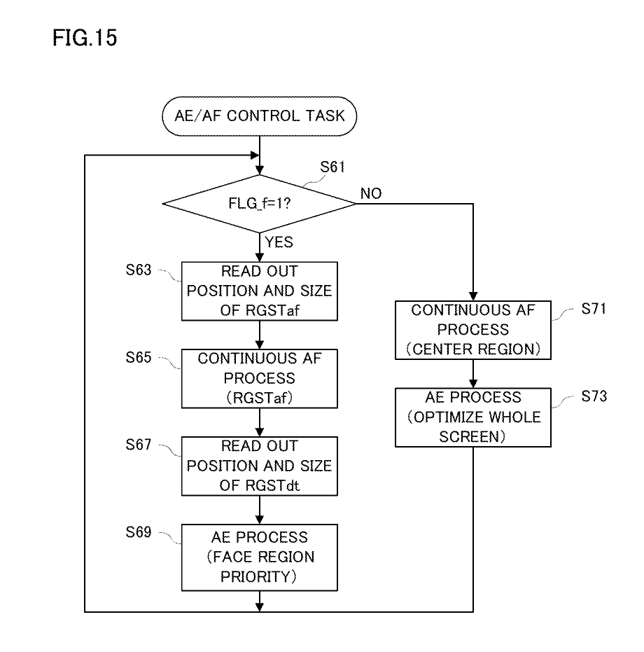

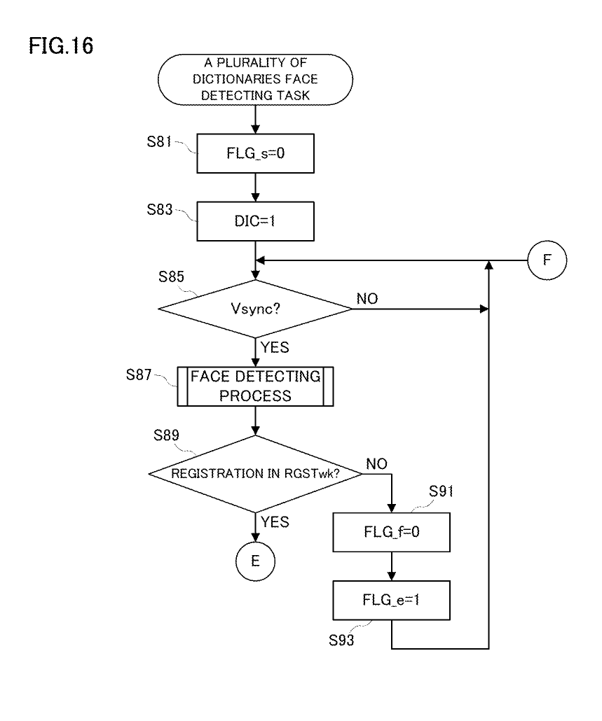

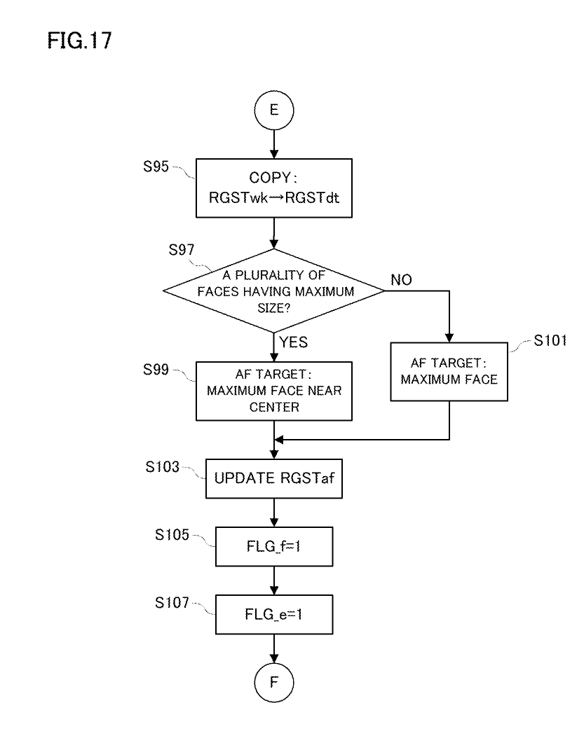

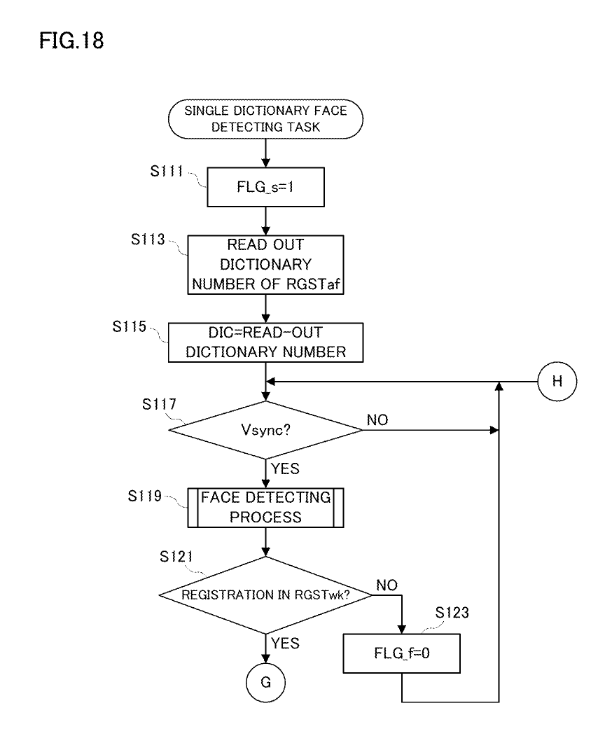

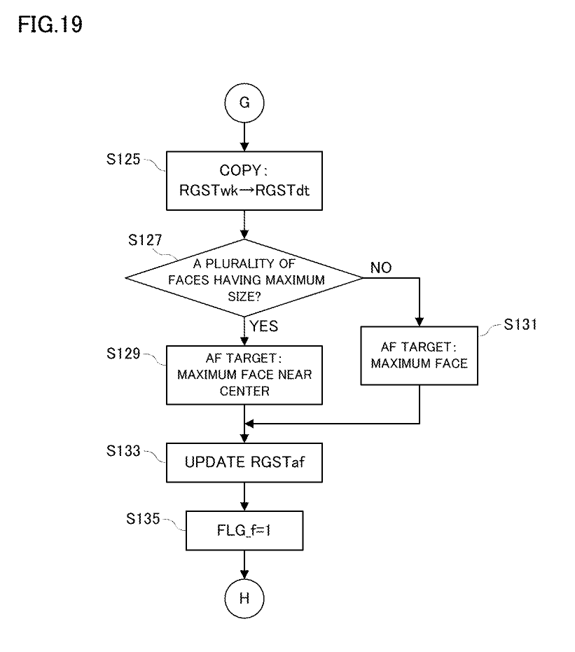

The CPU 26 executes a plurality of tasks including the imaging task shown in FIG. 12 to FIG. 14, the AE/AF control task shown in FIG. 15, the plurality of dictionaries face detecting task shown in FIG. 16 to FIG. 17 and the single dictionary face detecting task shown in FIG. 18 to FIG. 19, in a parallel manner. It is noted that control programs corresponding to these tasks are stored in the flash memory 44.

With reference to FIG. 12, in a step S1, the moving-image taking process is executed. As a result, a live view image representing a scene is displayed on the LCD monitor 38. In a step S3, the flag FLG_f is set to “0” as an initial setting. In a step S5, the AE/AF control task is activated, and in a step S7, the plurality of dictionaries face detecting task is activated.

In a step S9, it is determined whether or not the flag FLG_f indicates “1”, and when a determined result is YES, the process advances to a step S17 via processes in steps S11 and S13 whereas when the determined result is NO, the process advances to the step S17 via a process in a step S15.

In the step S11, the position and size registered in the face-detection register RGSTdt are read out. In the step S13, the graphic generator 48 is requested to display the face frame structure GF, based on the read out position and size. As a result, the face frame structure GF is displayed on the LCD monitor 38 in a manner to be adapted to the position and size of the face image detected under the plurality of dictionaries face detecting task. In the step S15, the graphic generator 48 is requested to hide the face frame structure GF. As a result, the face frame structure GF displayed on the LCD monitor 38 is hidden.

In the step S17, it is determined whether or not the recording start operation is performed toward the recording button 28rec, and when a determined result is NO, the process returns to the step S9 whereas when the determined result is YES, in a step S19, the MP4 codec 46 and the I/F 40 are activated so as to start the recording process. As a result, writing MP4 data into an image file created in the recording medium 42 is started.

In a step S21, it is determined whether or not the flag FLG_f indicates “1”, and when a determined result is NO, the process advances to a step S37 whereas when the determined result is YES, the process advances to a step S23.

In the step S23, the position and size registered in the face-detection register RGSTdt are read out. In the step S25, the graphic generator 48 is requested to display the face frame structure GF, based on the read out position and size. As a result, the face frame structure GF is displayed on the LCD monitor 38 in a manner to be adapted to the position and size of the face image detected under the plurality of dictionaries face detecting task.

In a step S27, it is determined whether or not the flag FLG_s indicates “1”, and when a determined result is YES, the process advances to a step S35 whereas when the determined result is NO, the process advances to a step S29. In the step S29, the plurality of dictionaries face detecting task that is being executed is stopped, and in a step S31, the single dictionary face detecting task is activated.

In a step S33, resetting and starting a timer 26t is executed. A timer value is used as three seconds, for example. In the step S35, it is determined whether or not the recording end operation is performed toward the recording button 28rec, and when a determined result is NO, the process returns to the step S21 whereas when the determined result is YES, the process advances to a step S51.

In the step S37, the graphic generator 48 is requested to hide the face frame structure GF. As a result, the face frame structure GF displayed on the LCD monitor 38 is hidden. In a step S39, it is determined whether or not the flag FLG_s indicates “1”, and when a determined result is YES, the process advances to a step S41 whereas when the determined result is NO, the process returns to the step S35.

In the step S41, it is determined whether or not a timeout occurs in the timer 26t, and when a determined result is NO, the process returns to the step S35 whereas when the determined result is YES, the single dictionary face detecting task that is being executed is stopped in a step S43.

In a step S45, the flag FLG_e is set to “0” as an initial setting, and in a step S47, the plurality of dictionaries face detecting task is activated. In a step S49, it is repeatedly determined whether or not the flag FLG_e indicates “1”, and when a determined result is updated from NO to YES, the process returns to the step S29.

In the step S51, the MP4 codec 46 and the I/F 40 are stopped in order to end the recording process. Moreover, a moving-image file that is a writing destination is subjected to the ending operation.

In a step S53, it is determined whether or not the flag FLG_s indicates “1”, and when a determined result is NO, the process returns to the step S9 whereas when the determined result is YES, the single dictionary face detecting task that is being executed is stopped in a step S55. Thereafter, the process returns to the step S7.

With reference to FIG. 15, in a step S61, it is determined whether or not the flag FLG_f indicates “1”, and when a determined result is NO, the process advances to a step S71 whereas when the determined result is YES, the process advances to a step S63.

In the step S63, the position and size of the AF target region are read out from the AF target register RGSTaf, and in a step S65, the continuous AF process is executed based on the read out position and size of the AF target region. As a result, the focus lens 12 is placed at a focal point in which the AF target region is noticed, and thereby, a sharpness of an AF target region in a live view image or a recorded image is improved.

In a step S67, the position and size of the face image are read out from the face-detection register RGSTdt, and in a step S69, the AE process is executed based on the read out position and size of the face image. As a result, a brightness of the live view image or the recorded image is adjusted by noticing the face image. Upon completion of the process in the step S69, the process returns to the step S61.

In a step S71, the continuous AF process in which a center of the scene is noticed is executed. As a result, the focus lens 12 is placed at a focal point in which the center of the scene is noticed, and thereby, a sharpness of a live view image or a recorded image is continuously improved.

In a step S73, the AE process in which the whole scene is considered is executed. As a result, a brightness of the live view image or the recorded image is adjusted by considering the whole scene. Upon completion of the process in the step S73, the process returns to the step S61.

With reference to FIG. 16, in a step S81, in order to declare that the single dictionary face detecting task is being stopped, the flag FLG_s is set to “0” as an initial setting. In a step S83, a variable DIC is set to “1” as an initial setting.

In a step S85, it is repeatedly determined whether or not the vertical synchronization signal Vsync is generated. When a determined result is updated from NO to YES, the face detecting process is executed in a step S87. Upon completion of the face detecting process, in a step S89, it is determined whether or not there is a registration of the face information in the work register RGSTwk, and when a determined result is YES, the process advances to a step S95 whereas when the determined result is NO, the process advances to a step S91.

In the step S91, the flag FLG_f is set to “0” in order to declare that the face of the person is undiscovered. In the step S93, the flag FLG_e is set to “1” in order to declare that executing the face detecting process is completed. Upon completion of the process in the step S93, the process returns to the step S85.

In a step S95, a registration content of the work register RGSTwk is copied on the face-detection register RGSTdt.

In a step S97, it is determined whether or not a plurality of face information having the maximum size is registered in the face-detection register RGSTdt. When a determined result is YES, in a step S99, a region indicated by face information nearest to a center of a scene out of the plurality of face information having the maximum size is determined as the AF target region. When the determined result is NO, in a step S101, a region indicated by face information having the largest size is used as the AF target region.

In a step S103, a position and a size of the face information determined as the AF target region in the step S99 or S101 and a dictionary number of a face dictionary of a comparing target are registered in the AF target register RGSTaf.

In a step S105, in order to declare that the face of the person has been discovered, the flag FLG_f is set to “1”. In a step S107, the flag FLG_e is set to “1” in order to declare that executing the face detecting process is completed. Upon completion of the process in the step S107, the process returns to the step S85.

With reference to FIG. 18, in a step S111, in order to declare that the single dictionary face detecting task is being executed, the flag FLG_s is set to “1” as an initial setting. In a step S113, the dictionary number of the comparing target registered in the AF target register RGSTaf is read out, and in a step S115, the variable DIC is set to the read-out dictionary number.

In a step S117, it is repeatedly determined whether or not the vertical synchronization signal Vsync is generated. When a determined result is updated from NO to YES, the face detecting process is executed in a step S119. Upon completion of the face detecting process, in a step S121, it is determined whether or not there is the registration of the face information in the work register RGSTwk, and when a determined result is YES, the process advances to a step S125 whereas when the determined result is NO, the process advances to a step S123.

In the step S123, the flag FLG_f is set to “0” in order to declare that the face of the person is undiscovered, and thereafter, the process returns to the step S117.

In the step S125, the registration content of the work register RGSTwk is copied on the face-detection register RGSTdt.

In a step S127, it is determined whether or not a plurality of face information having the maximum size is registered in the face-detection register RGSTdt. When a determined result is YES, in a step S129, a region indicated by face information nearest to a center of a scene out of the plurality of face information having the maximum size is determined as the AF target region. When the determined result is NO, in a step S131, a region indicated by face information having the largest size is used as the AF target region.

In a step S133, a position and a size of the face information determined as the AF target region in the step S12 or S131 and a dictionary number of a face dictionary of a comparing target are registered in the AF target register RGSTaf.

In a step S135, in order to declare that the face of the person has been discovered, the flag FLG_f is set to “1”. Upon completion of the process in the step S135, the process returns to the step S117.

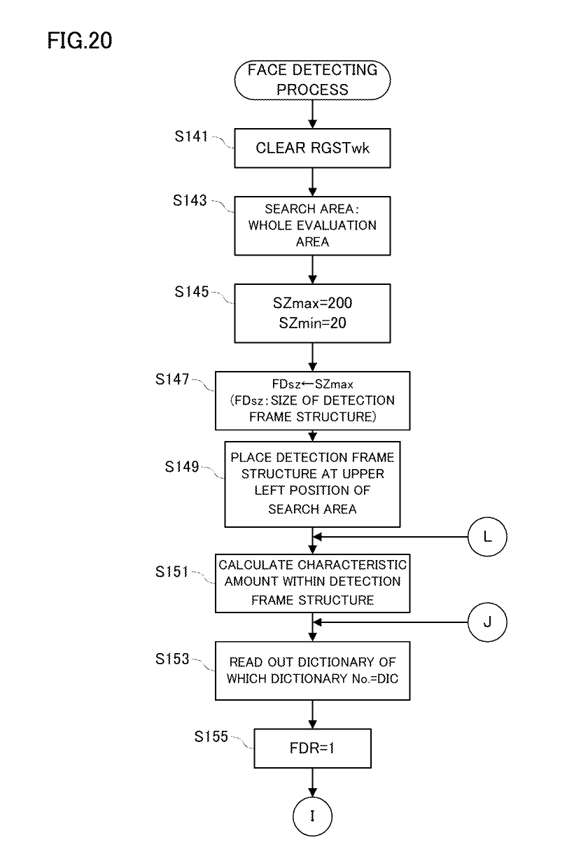

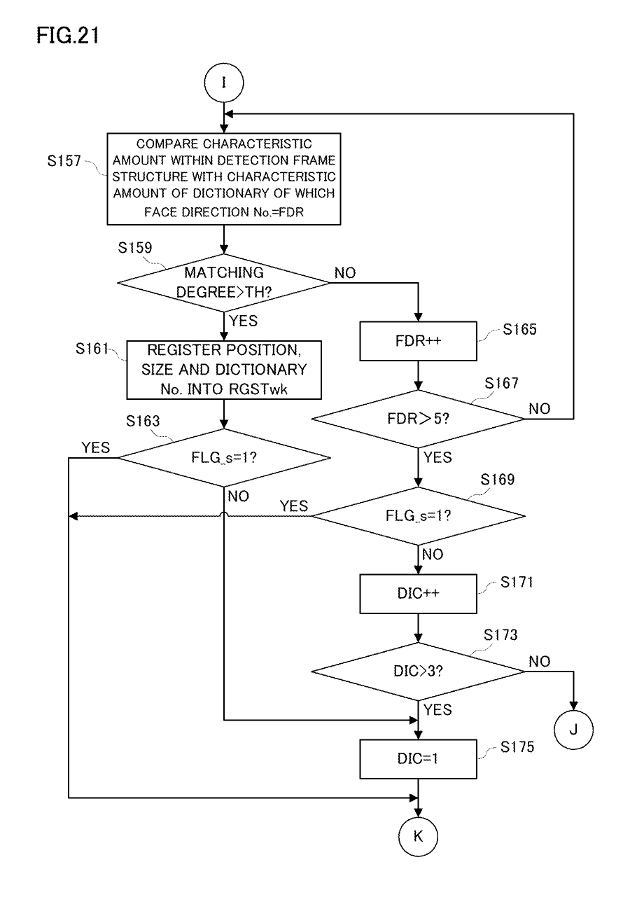

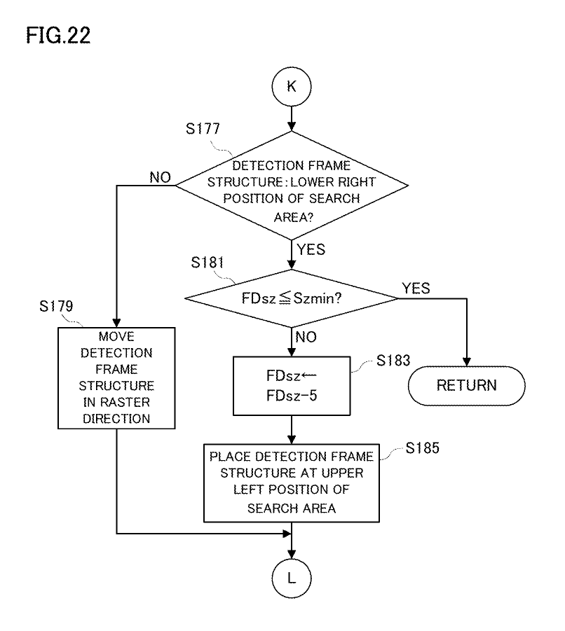

The face detecting process in the steps S87 and S119 is executed according to a subroutine shown in FIG. 20 to FIG. 22. In a step S141, the registration content is cleared in order to initialize the work register RGSTwk.

In a step S143, the whole evaluation area EVA is set as the search area. In a step S145, in order to define a variable range of the size of the face-detection frame structure FD, a maximum size SZmax is set to “200”, and a minimum size SZmin is set to “20”.

In a step S147, the size of the face-detection frame structure FD is set to “SZmax”, and in a step S149, the face-detection frame structure FD is placed at the upper left position of the search area. In a step S151, partial search image data belonging to the face-detection frame structure FD is read out from the search image area 32d so as to calculate a characteristic amount of the read-out search image data.

In a step S153, a face dictionary corresponding to the dictionary number indicated by the variable DIC is read out, and in a step S155, a variable FDR is set to “1”.

In a step S157, the characteristic amount calculated in the step S151 is compared with a characteristic amount of a dictionary image having a face-direction number indicated by the variable FDR out of the dictionary images contained in the face dictionary read out in the step S153. As a result of comparing, in a step S159, it is determined whether or not a matching degree exceeding the threshold value TH is obtained, and when a determined result is NO, the process advances to a step S165 whereas when the determined result is YES, the process advances to the step S161.

In the step S161, a position and a size of the face-detection frame structure FD at a current time point and the dictionary number of the face dictionary of the comparing target are registered, as the face information, in the work register RGSTwk. In a step S163, it is determined whether or not the flag FLG_s indicates “1”, and when a determined result is NO, the process advances to a step S175 whereas when the determined result is YES, the process advances to a step S177.

In the step S165, the variable FDR is incremented, and in a step S167, it is determined whether or not the variable FDR has exceeded “5”. When a determined result is NO, the process returns to the step S157 whereas when the determined result is YES, the process advances to a step S169. In the step S169, it is determined whether or not the flag FLG_s indicates “1”, and when a determined result is YES, the process advances to the step S177 whereas when the determined result is NO, the process advances to a step S171.

In the step S171, the variable DIC is incremented, and in a step S173, it is determined whether or not the variable DIC has exceeded “3”. When a determined result is NO, the process returns to the step S153 whereas when the determined result is YES, in the step S175, the variable DIC is set to “1”.

In the step S177, it is determined whether or not the face-detection frame structure FD has reached the lower right position of the search area, and when a determined result is YES, the process advances to a step S181 whereas when the determined result is NO, in a step S179, the face-detection frame structure FD is moved by a predetermined amount in a raster direction, and thereafter, the process returns to the step S151.

In a step S181, it is determined whether or not the size of the face-detection frame structure FD is equal to or less than “SZmin”, and when a determined result is YES, the process returns to an upper hierarchy whereas when the determined result is NO, the process advances to a step S183.

In the step S183, the size of the face-detection frame structure FD is reduced by a scale of “5”, and in a step S185, the face-detection frame structure FD is placed at the upper left position of the search area. Upon completion of the process in the step S185, the process returns to the step S151.

As can be seen from the above-described explanation, the image sensor 16 repeatedly outputs the image representing the scene captured on the imaging surface. The CPU 26 searches for the specific object image from the image outputted from the image sensor 16 by executing a plurality of comparing processes respectively corresponding to a plurality of postures possibly taken by the image sensor 16 in a direction around the axis orthogonal to the imaging surface. Moreover, the CPU 26 executes the processing operation different depending on the search result, and repeatedly records the image outputted from the image sensor 16 in parallel with the process of the image sensor 16. Furthermore, the CPU 26 executes the restricting process of restricting the comparing process to be executed to any one of the plurality of comparing processes, in association with the recording process.

The specific object image is searched from the image outputted from the imager by executing the plurality of comparing processes respectively corresponding to the plurality of postures of the camera. The comparing process executed by the searching process is restricted in association with the recording process. In the recording process, the image repeatedly outputted from the imager is repeatedly recorded in parallel with the outputting process. That is, the moving image is recorded.

Usually, upon recording the moving image, the posture of the camera is stabilized, and therefore, it has no effect on searching the specific object even when a part of the plurality of comparing processes respectively corresponding to the plurality of postures of the camera is restricted to execute. Therefore, it becomes possible to reduce the load of the searching process by restricting the comparing process. Thus, the searching performance is improved.

It is noted that, in this embodiment, in parallel with the imaging task, the plurality of dictionaries face detecting task is executed when the recording process is not executed, and the plurality of dictionaries face detecting task or the single dictionary face detecting task is executed during a period from a start to an end of the recording process. However, the plurality of dictionaries face detecting task or the single dictionary face detecting task may be executed in parallel with the imaging task when the recording process is not executed.

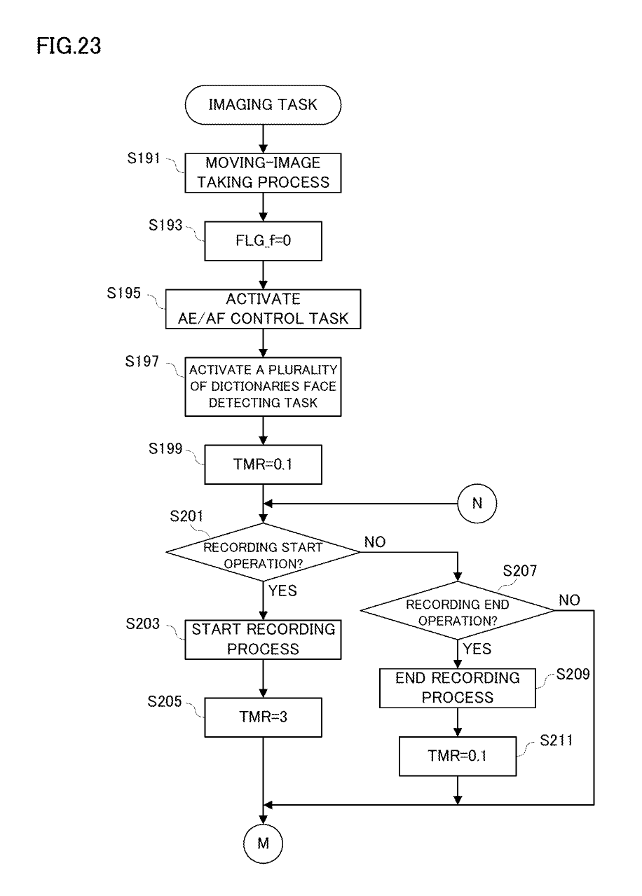

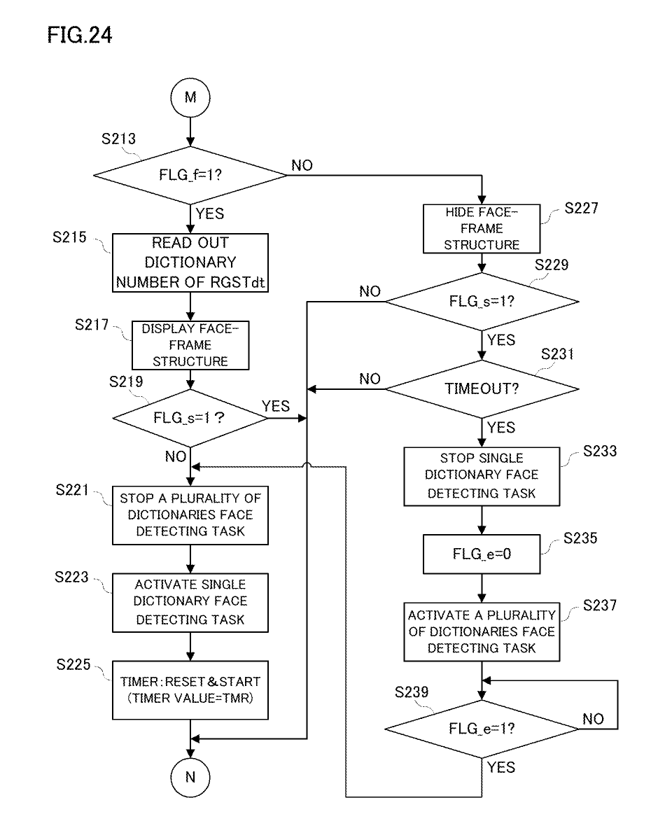

In this case, both of when the recording process is not executed and the period from the start to the end of the recording process, an execution cycle of the plurality of dictionaries face detecting task may be adjusted by using a timer, and the execution cycle may be extended in the period from the start to the end of the recording process. Moreover, in this case, the imaging task shown in FIG. 23 to FIG. 24 may be executed instead of the imaging task shown in FIG. 12 to FIG. 14.

With reference to FIG. 23, in a step S191, the moving-image taking process is executed, and in a step S193, the flag FLG_f is set to “0” as an initial setting. In a step S195, the AE/AF control task is activated, and in a step S197, the plurality of dictionaries face detecting task is activated. In a step S199, a variable TMR is set to “0.1”.

In the step S201, it is determined whether or not the recording start operation is performed toward the recording button 28rec, and when a determined result is NO, the process advances to a step S207 whereas when the determined result is YES, the process advances to a step S213 via processes in steps S203 and S205.

In the step S203, the MP4 codec 46 and the I/F 40 are activated so as to start the recording process, and in the step S205, the variable TMR is set to “3”.

In the step S207, it is determined whether or not the recording end operation is performed toward the recording button 28rec, and when a determined result is NO, the process advances to the step S213 whereas when the determined result is YES, the process advances to the step S213 via processes in steps S209 and S211.

In the step S209, the MP4 codec 46 and the I/F 40 are stopped in order to end the recording process. Moreover, a moving-image file that is a writing destination is subjected to the ending operation. In the step S211, the variable TMR is set to “0.1”.

In the step S213, it is determined whether or not the flag FLG_f indicates “1”, and when a determined result is NO, the process advances to a step S227 whereas when the determined result is YES, the process advances to a step S215.

In the step S215, the position and size registered in the face-detection register RGSTdt are read out. In a step S217, the graphic generator 48 is requested to display the face frame structure GF, based on the read out position and size. As a result, the face frame structure GF is displayed on the LCD monitor 38 in a manner to be adapted to the position and size of the face image detected under the plurality of dictionaries face detecting task.

In a step S219, it is determined whether or not the flag FLG_s indicates “1”, and when a determined result is YES, the process returns to the step S201 whereas when the determined result is NO, the process advances to a step S221. In the step S221, the plurality of dictionaries face detecting task that is being executed is stopped, and in a step S223, the single dictionary face detecting task is activated.

In a step S225, resetting and starting the timer 26t is executed by using a value indicated by the variable TMR as a timer value.

In the step S227, the graphic generator 48 is requested to hide the face frame structure GF. As a result, the face frame structure GF displayed on the LCD monitor 38 is hidden. In a step S229, it is determined whether or not the flag FLG_s indicates “1”, and when a determined result is NO, the process returns to the step S201 whereas when the determined result is YES, the process advances to a step S231.

In the step S231, it is determined whether or not a timeout occurs in the timer 26t, and when a determined result is NO, the process returns to the step S201 whereas when the determined result is YES, the single dictionary face detecting task that is being executed is stopped in a step S233.

In a step S235, the flag FLG_e is set to “0” as an initial setting, and in a step S237, the plurality of dictionaries face detecting task is activated. In a step S239, it is repeatedly determined whether or not the flag FLG_e indicates “1”, and when a determined result is updated from NO to YES, the process returns to the step S221.

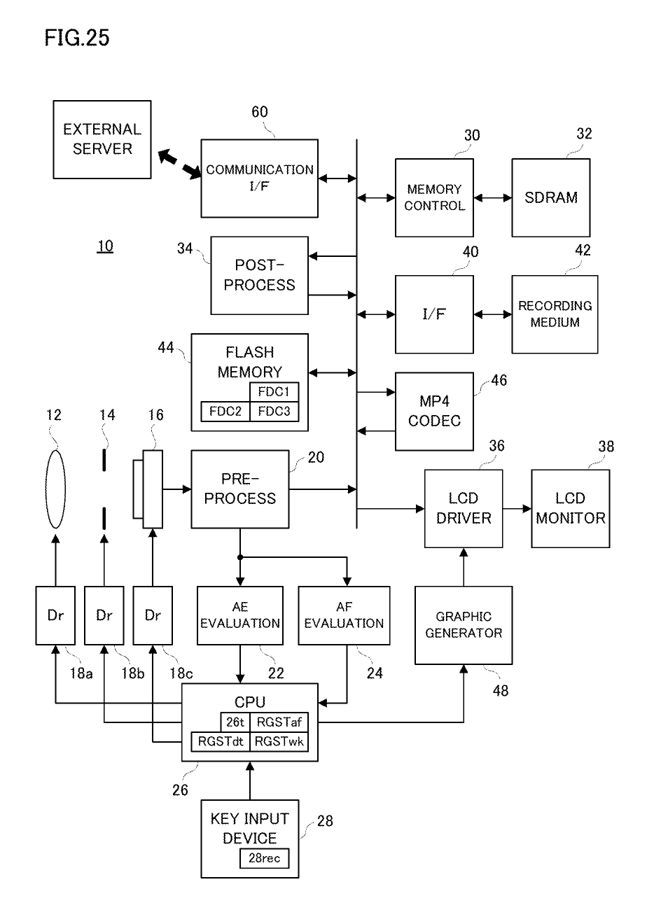

Moreover, in this embodiment, the control programs equivalent to the multi task operating system and the plurality of tasks executed thereby are previously stored in the flash memory 44. However, a communication I/F 60 may be arranged in the digital video camera 10 as shown in FIG. 25 so as to initially prepare a part of the control programs in the flash memory 44 as an internal control program whereas acquire another part of the control programs from an external server as an external control program. In this case, the above-described procedures are realized in cooperation with the internal control program and the external control program.

Moreover, in this embodiment, the processes executed by the CPU 26 are divided into a plurality of tasks including the imaging task shown in FIG. 12 to FIG. 14, the AE/AF control task shown in FIG. 15, the plurality of dictionaries face detecting task shown in FIG. 16 to FIG. 17 and the single dictionary face detecting task shown in FIG. 18 to FIG. 19. However, these tasks may be further divided into a plurality of small tasks, and furthermore, a part of the divided plurality of small tasks may be integrated into another task. Moreover, when a transferring tasks is divided into the plurality of small tasks, the whole task or a part of the task may be acquired from the external server.

Moreover, in this embodiment, the present invention is explained by using a digital video camera, however, a digital still camera, cell phone units or a smartphone may be applied to.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic camera comprising:
an imager which repeatedly outputs an image representing a scene captured on an imaging surface;
a searcher which searches for a specific object image from the image outputted from said imager by executing a plurality of comparing processes respectively corresponding to a plurality of postures possibly taken by said imager in a direction around an axis orthogonal to said imaging surface;
an executer which executes a processing operation different depending on a search result of said searcher;
a recorder which repeatedly records the image outputted from said imager in parallel with a process of said imager; and
a restrictor which executes a restricting process of restricting the comparing process executed by said searcher to any one of the plurality of comparing processes, in association with a process of said recorder.

2. An electronic camera according to claim 1, wherein said searcher executes the plurality of comparing processes by respectively using a plurality of image dictionaries different from one another.

3. An electronic camera according to claim 1, wherein a comparing process excluded from a target of the restricting process corresponds to a posture of said imager at a time point at which the specific object image is detected.

4. An electronic camera according to claim 1, wherein said restrictor includes a starter which starts the restricting process in response to detection of said searcher, and a stopper which stops the restricting process in response to non-detection of said searcher.

5. An electronic camera according to claim 1, further comprising an additional restrictor which executes the restricting process at a first frequency, in response to detection of said searcher in a period during which the process of said recorder is suspended, wherein said restrictor executes the restricting process at a second frequency less than the first frequency, in response to the detection of said searcher in a period during which the process of said recorder is executed.

6. An electronic camera according to claim 1, wherein said executor includes an adjuster which adjusts an imaging condition by noticing the specific object image detected by said searcher.

7. An electronic camera according to claim 1, wherein the specific object image is equivalent to a face image of a person.

8. An imaging control program recorded on a non-transitory recording medium in order to control an electronic camera provided with an imager which repeatedly outputs an image representing a scene captured on an imaging surface, the program causing a processor of electronic camera to perform the steps comprises:
a searching step of searching for a specific object image from the image outputted from said imager by executing a plurality of comparing processes respectively corresponding to a plurality of postures possibly taken by said imager in a direction around an axis orthogonal to said imaging surface;
an executing step of executing a processing operation different depending on a search result of said searching step;
a recording step of repeatedly recording the image outputted from said imager in parallel with a process of said imager; and
a restricting step of executing a restricting process of restricting the comparing process executed by said searching step to any one of the plurality of comparing processes, in association with a process of said recording step.

9. An imaging control method executed by an electronic camera provided with an imager which repeatedly outputs an image representing a scene captured on an imaging surface, comprising:
a searching step of searching for a specific object image from the image outputted from said imager by executing a plurality of comparing processes respectively corresponding to a plurality of postures possibly taken by said imager in a direction around an axis orthogonal to said imaging surface;
an executing step of executing a processing operation different depending on a search result of said searching step;
a recording step of repeatedly recording the image outputted from said imager in parallel with a process of said imager; and
a restricting step of executing a restricting process of restricting the comparing process executed by said searching step to any one of the plurality of comparing processes, in association with a process of said recording step.
